(19) United States
(12) Patent Application Publication
(10) Pub. No.: US 2006/0204142 A1
(43) Pub. Date: Sep. 14, 2006

(54) Ranking of images in the results of a search

(75) Inventors: James Lee West, Oxford (GB); Michael David Fischer, Reading (GB)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Alamy Limited

(21) Appl. No.: 11/088,877

(22) Filed: Mar. 25, 2005

(30) Foreign Application Priority Data
Mar. 11, 2005 (GB) 0505007.5

(51) Int. Cl. G06F 17/30; G06F 17/00; G06K 9/54

(52) U.S. Cl. 382/305; 707/3; 707/104.1

(57) ABSTRACT

A method is provided for determining a ranking score for an image or group of related images among a plurality of images accessible by a search engine, such that the ranking score is usable to determine the order in which the images are presented in the results of a search conducted by the search engine. The method comprises monitoring the number of times the image (or the images in the group of related images) is presented for viewing by predetermined users in the results of searches conducted by the search engine. The level of active interest shown by the predetermined users in the image or images presented for viewing in the search results is then monitored, for example by determining the number of times that users select a thumbnail of the image for viewing on an enlarged scale. Finally a ranking score is assigned to the image or images based on the monitored level of active interest as a proportion of the number of times the image or images are presented for viewing by the predetermined users. This then enables an identified set of images to be ordered in such a manner as to take into account the ranking scores of the images, in order to enable users to access the images that they require more quickly and conveniently.

### BACKGROUND OF INVENTION

1. Field of the Invention

This invention relates to the ranking of images in the results of a search carried out by a search engine for presentation to a user.

2. Description of the Related Art

In the modern age of data storage and communication, search engines are widely used to identify text-based documents meeting selected criteria. Each document has associated textual data called “metadata”, which is typically compiled manually, and the search engine identifies a list of documents corresponding to user-input search terms by matching the search terms to the metadata. Search engine results are presented to the user by displaying a list of the names of the identified documents on a computer monitor or the like. Conventional search engines use algorithms to determine the order in which the identified documents are listed for presentation to a user.

US-A-2002/0123988 describes a known algorithm for ordering a list of text-based documents identified by a search engine in response to input search terms by assigning a score to each document based on usage information. The usage information relates to the number of users that have visited the document.

Image search engines are also used for the sale of products, including the sale of rights in images themselves. For example, photography agencies have benefited from technical advances in digital photography and are able to trade over the Internet as so-called “on-line stock photography agencies”. In particular, photography agencies may offer images (photographs, illustrations, moving images and the like) from a “stock” or “bank” of digital images stored in a database, which may be viewed using a search engine, by potential customers throughout the world. As with conventional search engines, an image search engine performs a search on input textual search terms. Thus, each image has associated textual metadata that is manually input and associated with the image. Such metadata may include the author/photographer name, date, colour or keywords for the subject of the image. Thus the metadata associated with an image is more limited than the metadata associated with documents that are primarily text-based.

An image search engine of an on-line stock photography agency produces the search results by displaying the images to the customer in an arbitrary order, determined by a conventional algorithm designed for searching documents. A typical search for images on user-input each terms may reveal hundreds of images, and so groups of about ten “thumbnail” images are typically shown together to the user as a “page” on screen. However, the customer may need to scroll through large numbers of such groups of identified images in order to find an image that suits his or her needs and, when a suitable image is identified, look at the image in greater detail by enlarging the thumbnail image on screen. This makes image searching time consuming, particularly bearing in mind the ever-increasing numbers of images that may be contained in an agency database.

The present invention seeks to address the aforementioned limitations of using conventional text-based search engine algorithms designed for searching documents in image search engines.

### SUMMARY OF THE INVENTION

In accordance with a first aspect, the present invention provides a method of determining a ranking score for an image or group of related images among a plurality of images accessible by a search engine, such that the ranking score is usable to determine the order in which the images are presented in the results of a search conducted by the search engine, the method comprising:

monitoring the number of times said image or said images in said group of related images are presented for viewing by predetermined users in the results of searches conducted by the search engine,

monitoring a level of active interest shown by said predetermined users in said image or images presented for viewing in said search results, and

determining a ranking score for said image or images based on the monitored level of active interest as a proportion of the number of times said image or images are presented for viewing by said predetermined users.

Thereafter an identified set of images may be ordered in such a manner as to take into account the ranking scores of the images, in order to enable users to access the images that they require more quickly and conveniently. Data concerning the relative ranking of images may also be of use to contributors of the images to be accessed in that it can be used by such contributors to assist in making decisions about which images to submit and what data to submit in association with the images. Contributors can also analyse which search terms resulted in customer interest in their images.

A ranking score may be assigned to an image by ranking of the particular image on the basis of the monitored level of active interest in that image as a proportion of the number of times that the image has been viewed, or alternatively a ranking score may be assigned to an image by ranking of a group of related images of which the particular image forms a part on the basis of the monitored level of active interest in image within that group as a proportion of the number of times that images within that group have been viewed. A group of images in this case may be images by the same photographer, an automatically selected sub-group by photographer, or a collection of images by different photographer represented by one agency. Other attributes that may be indicators associated with a grouping are colour (colour or black and white), date taken, location (geographical coordinates, orientation (portrait, landscape, square), legal status (property release, model release), image type (illustration, photograph), technique (composite, digital), or any other machine-determinable feature. The ranking of images within a group, for example of 300 images of couples holding hands in front of the Eiffel Tower, will generally differ based on past indicators of active interest in each of the images as a proportion of the number of times that the image has been viewed.

The monitoring preferably comprises recording the number of times that predetermined users, such as customer users, are presented with the image or an image within the group of related images in search engine results over said monitoring period.

The level of active interest may be determined based on the number of purchases, or the overall value of purchases, of said image or said related images by said predetermined users. Alternatively or additionally the level of active interest may be determined based on the number of instances of viewing in detail of said image or said related images by said predetermined users. The viewing in detail of said image or images may comprise user selection of said image or one of said related images for viewing at increased size relative to other images presented in said search results. The viewing may also be in the form of transfer of the image to a lightbox, that is a tool on the website where users can place images of interest without having to put them in their shopping cart, for example so as to enable users to run multiple projects simultaneously or to email image selections to a colleague for review.

Such viewing in detail may involve the user of a client workstation, in communication with said search engine running on a network/server device which provides search results as pages of thumbnail images, clicking on a thumbnail image to view the image at “full size”, and/or the user adjusting the size of the image, for instance by zooming in on the “full size” image to study the image detail on the workstation monitor. The detailed viewing may also include a user viewing factual information about the image such as photographer/author and price and availability information associated with the image, as well as making purchases.

Furthermore the ranking may be linearly or non-linearly related to the relative level of interest shown and may be varied relative to the monitored levels of the indicators of interest according to predetermined criteria. For example a particular indicator of interest may be given greater or lesser importance within a certain boundary range of that indicator relative to its value outside that boundary range. It is also possible that the user conducting a search will be able to have some control over the weighting factors that are applied in ranking of the search results. For example the user may be given a choice between two or more preset weighting implementations when carrying out a search.

Typically the method further comprises receiving user input search criteria during a search, identifying images with metadata matching the input search criteria, and presenting the images selected as a result of the search for viewing by the user.

In a preferred embodiment, the method further comprises receiving user profile data indicative of general preferences of a user conducting a search on the basis of user specified search criteria separate from the user profile data and correlating the user profile data with image profile data associated with each image or group of related images presented for viewing by the user in the results of the search, whereby the order in which the images are presented in the results of the search is influenced by such correlation. This embodiment thus enables images identified in response to user input search criteria entered into the search engine to be ordered or ranked according to the user profile, as well as the image ranking score. In this way, the more highly ranked images are more likely to be of interest to the particular user.

Thus each user may have a user profile that includes data that determines whether the user's review of images is to be taken into account when determining an image ranking score, and if so the extent to which the particular user's review is considered. Typically, the predetermined users are customer users that have already made image purchases.

Preferably the method further comprises receiving customised user profile data indicative of specific preferences, such as type of audience for the image, of a user conducting a search on the basis of user specified search criteria separate from the current user profile data and correlating the current user profile data with image profile data associated with each image or group of related images presented for viewing by the user in the results of the search, whereby the order in which the images are presented in the results of the search is influenced by such correlation.

The method may also comprise receiving user importance data indicative of the importance of a user based on factors such as the type of user and the recent purchasing history of the user, and taking into account the user importance data of each of said predetermined users in said determination of the ranking score for said image or images based on the monitored level of active interest shown by said predetermined users in said image or images.

Furthermore the images accessible by the search engine may be classified according to type, such as image type or potential customer type, and a ranking score may be determined for the ranking of the image or images Within the images of each type based on the monitored level of active interest as a proportion of the number of times said image or images are presented for viewing.

In a development of the invention the change of the ranking score allotted to an image or images in a group of related images is monitored over time, and an accelerated ranking score is imparted to the image or images based on extrapolation of the trend in the change of the ranking score over time indicated by such monitoring.

In accordance with a second aspect, the present invention provides a processor for determining the order in which images are presented in the results of a search through an image catalogue conducted by a search engine, the processor comprising:

first monitoring means for monitoring the number of times an image or images in a group of related images are presented for viewing by predetermined users in the results of searches conducted by the search engine,

second monitoring means for monitoring a level of active interest shown by said predetermined users in said image or images presented for viewing in said search results, and

ranking means for determining a ranking score for said image or images based on the monitored level of active interest as a proportion of the number of times said image or images are presented for viewing by said predetermined users, the order in which the images are presented being dependent on their ranking score.

In accordance with a third aspect, the present invention provides computer readable storage medium incorporating a computer program for carrying out a method of determining a ranking score for an image or group of related images among a plurality of images accessible by a search engine, such that the ranking score is usable to determine the order in which the images are presented in the results of a search conducted by the search engine, the method comprising:

monitoring the number of times said image or said images in said group of related images are presented for viewing by predetermined users in the results of searches conducted by the search engine,

monitoring a level of active interest shown by said predetermined users in said image or images presented for viewing in said search results, and

determining a ranking score for said image or images based on the monitored level of active interest as a proportion of the number of times said image or images are presented for viewing by said predetermined users.

### BRIEF DESCRIPTION OF THE DRAWINGS

The present invention will now be described, by way of example, with reference to the accompanying drawings in which:

FIG. 1 is a schematic view of an image ranking processor, in accordance with an embodiment of the present invention, which is connected to the Internet;

FIG. 2 is a schematic view of the imaging ranking processor of FIG. 1 showing the data stored and generated therein;

FIG. 3 is a flow diagram illustrating the general method steps performed by a search engine within the processor of FIG. 1;

FIG. 4 is a flow diagram illustrating the method steps for determining an image ranking score in accordance with the present invention, and

FIG. 5 is a flow diagram illustrating the method of monitoring the response of users to new images, in accordance with the present invention.

### DETAILED DESCRIPTION OF THE PREFERRED EMBODIMENTS

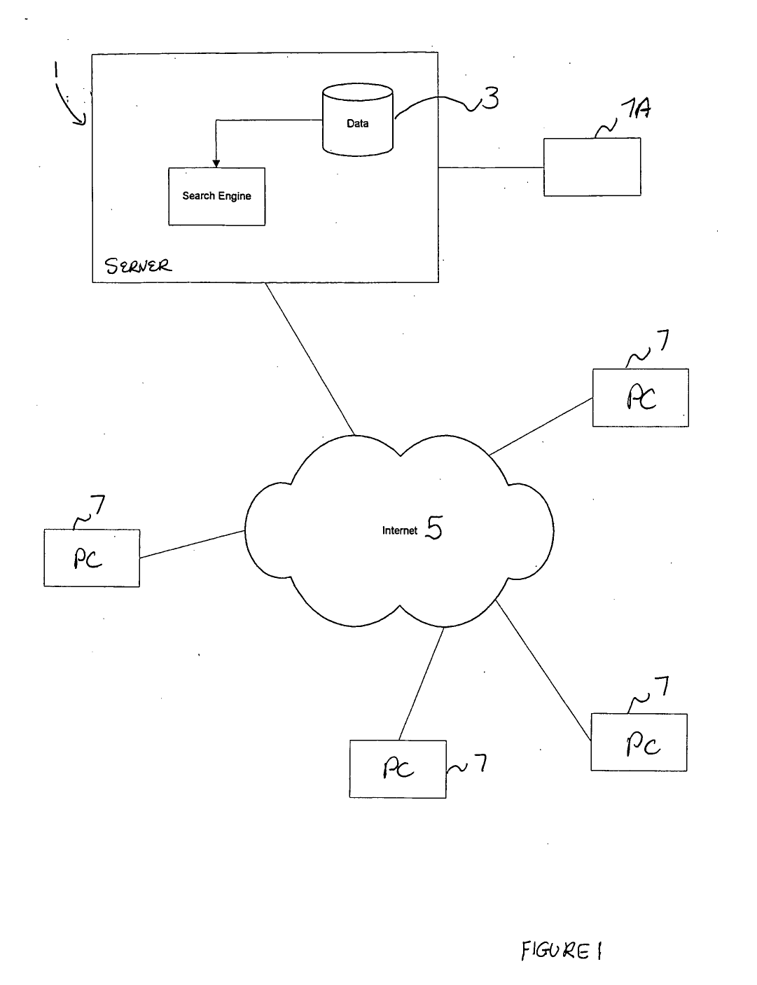

FIG. 1 illustrates an image ranking processor 1 in accordance with an embodiment of the present invention. In the preferred embodiment, the processor 1 comprises, or is associated with, one or more servers of an online stock photography agency, although it will be appreciated that the present invention may be used in ranking images in other contexts, such as other image based search engines. Thus, a database 3 stores high resolution digital images I. Images I are offered to customers, namely picture buyers, such as advertising agencies, design companies and publishers, for the purchase of rights for the use thereof, and potentially for downloading the images over the Internet 5 to a customer computer 7. It will be appreciated that the images may be moving images as well as static images.

In addition, contributors or suppliers may contribute digital images I to the database 3 of images for purchase, and such contributors may send high-resolution images to the database 3 and may caption and edit new and existing images within the database 3.

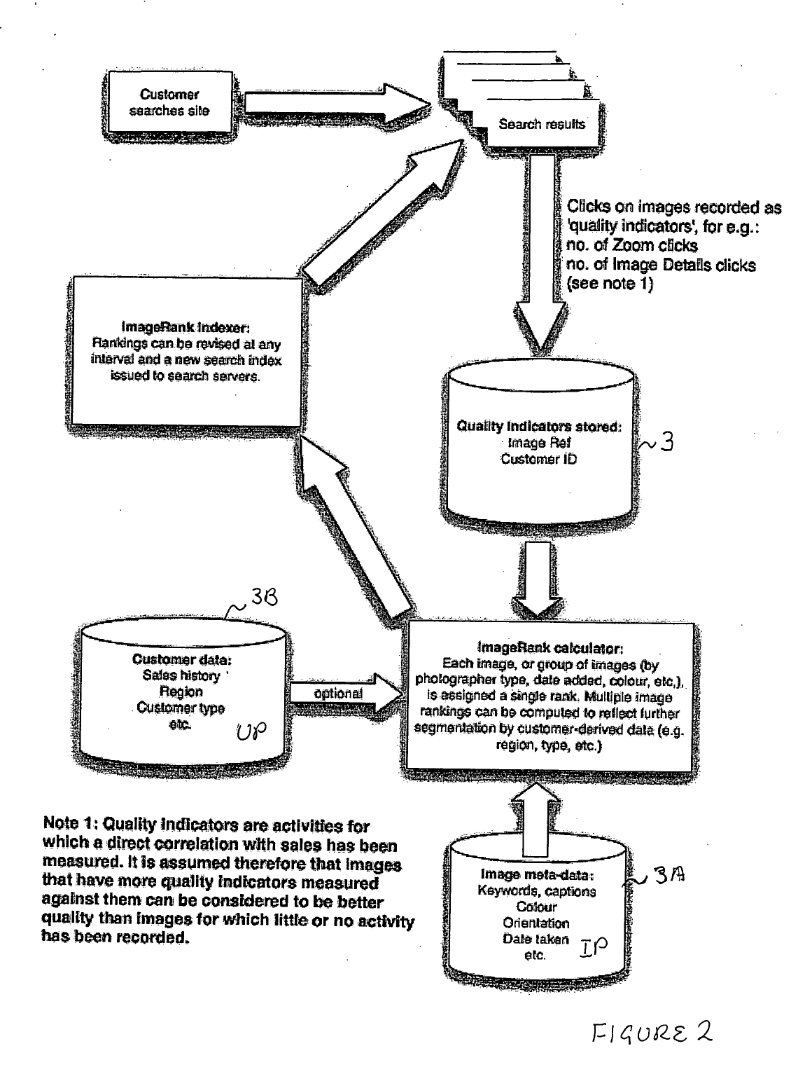

Referring to FIG. 2, the imaging ranking processor 1 comprises a database 3 for storing data relating to images (IP) and users (UP). The database 3 includes, for each image, an image profile IP comprising user input text-based information (“meta-data”) and may comprise manually defined characteristics of the image. For instance, the image profile IP may include text-based keywords or “captions” for the image, such as the subject of the image. In addition, the image profile IP may contain other text-based factual information about the image, such as the author, date of the image, price and/or availability of the image. Such information must be manually entered when the corresponding image is placed in the database 3.

Furthermore, computer-determined attributes of the image may be included in the image profile IP, such as whether the image is colour or black and white, the size of the image and the image data, the orientation of the image etc. It will be appreciated that these attributes may also be manually entered. Other machine-determinable features of the image may be included within the image profile. Again, such attributes may be determined when the image is placed in the database 3.

Finally, the image profile IP may include automatically determined profile information after the image is entered in the database 3. Importantly, the image profile includes information associated with the activity level and/or history of viewing and/or purchasing of the image or related images (such as images originating from the same photographer), as described in detail below. Such information is preferably dynamically updated, for instance by monitoring the viewing and/or purchasing of images either continuously or at predetermined intervals (e.g. daily, weekly, monthly etc). In accordance with the present invention, this information is treated as a “Quality Indicator” for the image, and is used in the determination of an image ranking score, as described below.

In addition, database 3 stores a user profile UP for each user (customer or contributor) comprising text-based information about the user. For example, for each customer user, the user profile UP may include the type of customer (e.g. advertising, design, books, newspaper or magazine publisher); the gender of the customer; the profession of the customer; the location/region of the customer; and the time of day, date and season of the search. The customer may also enter customised user profile information, corresponding to the user profile that might be used by a particular type of audience (male/female/children) for a publication for which the image is sought and the publication date, so that the user may perform a search as if “in the shoes of” that particular audience.

In addition, dynamically updated, historical information about the customer's activity may be stored in the user profile UP. Importantly, this information may include a “customer importance” level, based on the type of customer and history of purchasing images. The level of importance of a customer is a “Quality Indicator” for the customer and is based on historical purchasing data and may be continually updated to reflect the customer's recent purchasing history. The Quality Indicator for a user is used to determine whether, and the extent to which, the user's activity (e.g. clicking on and zooming of images; purchasing of images) is monitored during searching, which monitoring is significant when determining the image ranking score for images, as described below.

Finally, the user profile UP for both contributors and customers may include permissions. The permissions may, inter alia, allow the contributor or customer to enter or modify attributes associated with the users preferences, as discussed below.

The present inventors working in the field of online stock photography agencies have determined through research and data analysis that, if particular types of users (“Quality Users”) show an interest in an image (or group of related images), for instance by viewing the image at full size and/or zooming; then there is relatively high probability that the image (or an image within the related group) will be purchased, whether by the particular Quality User or another customer. In addition, the present inventors have determined that, if Quality Users purchase an image, there is an even higher probability that the image (or an image within the related group) will be purchased again, whether by the particular Quality User or another customer. Conversely, if Quality Users consistently scroll through and ignore an image or related groups of thumbnail images, then there is a low probability that such images will be sold.

The present inventors realised that it is possible to monitor the activity of Quality Users in connection with images during searches, in order to collect data that relates to the “quality” of the images. It should be noted that in the present context “quality” is intended to mean commercially saleable quality and not to qualify the artistic or aesthetic merit of the images. This image quality data can be used by the search engine to present customers with search results in which the first group of images displayed are the “top ranked” images that have the highest probability of being suitable for purchase (i.e. meeting the customer's needs).

Thus, in accordance with the present invention, a method is performed to calculate a “ranking score” for each image, or for a group of related images, to be used in determining the ranking of an image in a set of search results. The calculated “ranking score” of each image is used as a factor for determining the position that the image is placed in the displayed results of a search in which the image is identified relative to the other images. Thus, images with the highest ranking score should normally be presented in the first group of thumbnail images presented on the first page the search results. As regards the ordering of the thumbnail images on each page, the highest ranking images may be shown first in order with the images being considered as being scanned by the user from left to right and in successive lines down the page, or alternatively the highest ranking images may be shown on parts of the page that are judged to render them most immediately visible to the user, for example in the centre of the page.

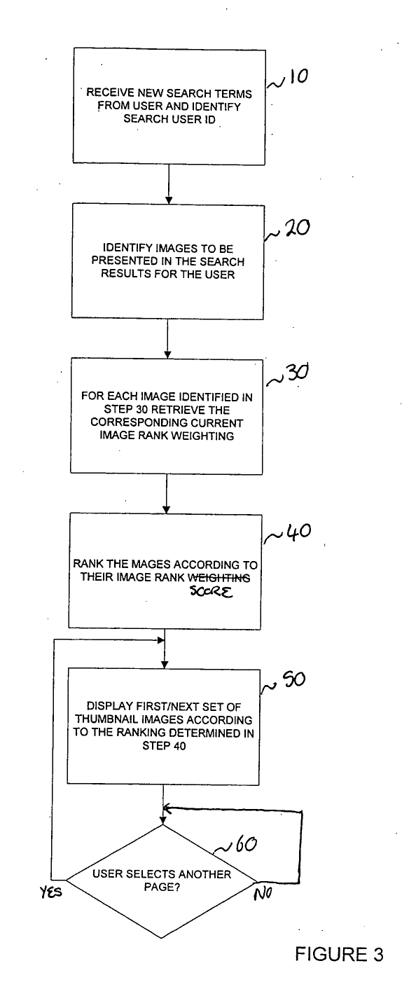

FIG. 3 illustrates the general steps performed in a method for presenting image results of an image search engine according to an embodiment of the present invention. The method is typically implemented within the imaging ranking processor 1 in the form of one or more computer programs in a search engine, running on, or associated with a server, as illustrated in FIG. 1. It will be appreciated that other forms of implementation are possible. As shown in FIG. 1, in the illustrated embodiment the server is a web server for a website on the Internet 5.

The program starts in response to a user logging on to the web server, which may involve entering a password and/or user identifier (such as user name) and sending search terms to the web server by entering keywords and/or other information on the GUI associated with the image searching facility on the website.

At step 10, the program receives the user input search terms and user identification, and retrieves, either at this stage or subsequently, the user profile for the user from database 3. At step 20, the program performs a search of the metadata of all the images in the database 3, for which the user has permission to search (as defined, for example, by the “permissions” in the user profile), and identifies all the images I that match the input search terms.

At step 30, the program retrieves from the image profile IP of each of the identified images I, the current image rank weighting factor thereof. The image profile data is retrieved from the database concurrently with, or in response to, the identification of the images I in step 20.

At step 40, the program determines the ranking order of the images I according to an algorithm that determines the ranking score of each of the images. An appropriate algorithm may be summarised as follows:

Calculating ImageRank (IR)

ZoomsIR=(ImageZooms/Views)×constantA

SalesIR=(ImageSales/Views)×constantB

Weighting factor=ZoomsIR/constantC

IR=SalesIR+Weighting factor

Steps may also be included to normalise the IR scores and set a maximum of 100 for the top score.

The algorithm correlates the user profile UP information with the current image rank weighting of each of the images I identified in step 30. This correlation results in a ranking score for each image I, which is used to determine the ranking order of the images I. Possible correlation methods are discussed in detail below. In this step, the program may also divide the ranked images I into groups or “pages” to be displayed together on a display screen. It will be appreciated that the number of images to be displayed on a page may be predetermined or user selected.

At step 50, the program displays to the user a first group of the identified images I as thumbnail images on a single page, in an order in accordance with the ranking determined at step 40. The program then waits for the user to select another page of images I. If the user selects another page, then the program returns to step 50 and displays the selected page of images in the ranking order determined at step 40. Whilst the program is waiting at step 60, in a preferred embodiment the program may monitor the user's activity in relation to the displayed thumbnail images for updating the image ranking score. In a preferred embodiment, the activity of only certain users is monitored, which users have a high user Quality Indicator within their user profiles UP.

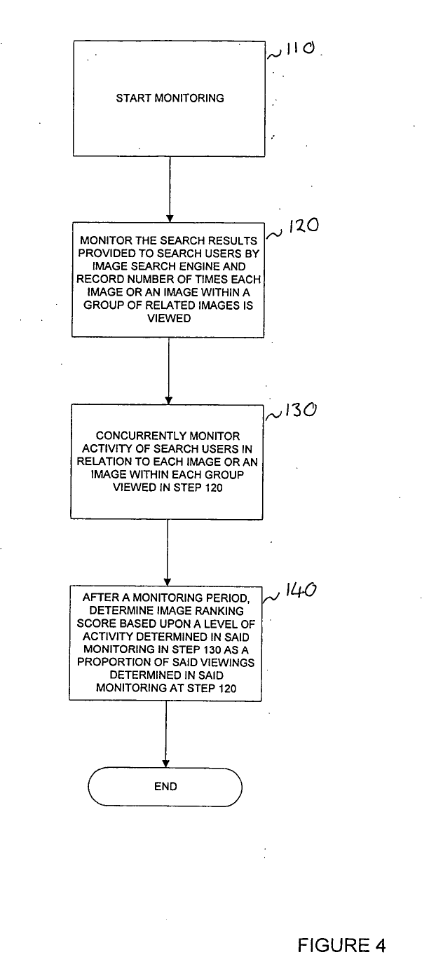

FIG. 4 illustrates the steps performed in the method for determining the image ranking score that may be used in the method of FIG. 3 according to an embodiment of the present invention. The method is typically implemented within the imaging ranking processor 1 in the form of one or more computer programs associated with the database of FIG. 2.

The method of FIG. 4 is typically performed at periodic intervals in relation to images in the collection of images stored in the database 3. It will be appreciated that it could be performed in relation to specific images, for instance whenever a new or modified image is entered in the database 3 by any user, or could be performed at regular intervals, such as weekly or monthly. However, it is preferable to perform the method upon or shortly after an image is first submitted to the database 3 to ensure that the image is appropriately ranked with respect to other images as quickly as possible.

At step 110, the program starts the monitoring of the search results provided by the search engine. At step 120, the program monitors the number of times each image or images within a group of related images are displayed, and in particular viewed by a Quality User as a thumbnail image in a page of search results. Typically, images may be monitored in groups of related images, such as images from the same contributor and/or supplier, the same photographer or a group of images defined by the contributor, for instance by a pseudonym. Thus in step 120 the monitoring may record the viewing of several different thumbnail images, from a group of related images, as part of one set of search results provided to the user by the search engine.

At step 130, the program concurrently monitors the response of Quality Users to the thumbnail images of each image or images within a group of images when viewed by the users in search results. In particular, the program records the number of occasions of occurrence of activities denoting user interest, such as thumbnail image enlargement, viewing of data about the image, and purchasing of the image. In both steps 120 and 130, the program monitors or records only the activities of customer users having a high “Quality Indicator” value in the database 3. In this way, data is only collected from customers deemed to be important in the assessment of the quality of images. The monitoring takes place for a desired monitoring period which is sufficient to collect data for determining image quality based on current user trends.

At step 140, at the end of a monitoring time period, the program determines an image ranking score for each image or each group of related images according to the results of the monitoring in steps 120 and 130. In particular, the image ranking score is highest for images having a high number of associated activities denoting interest, such as enlargement, zooming, image manipulation, viewing of associated data and purchase, relative to the number of times the images are viewed. Once the image ranking score has been determined at step 140, it is stored in the image profile data in the database 3 for use in further searches, and the program ends.

Any key words or phrases assigned to an image would themselves have a ranking relative to the image in so far as searches utilising such key words or phrases is concerned. Thus, if two or more sets of key words having different rankings are associated with an image, the image ranking score assigned to that image in the search results may be different depending on which of the different sets of key words is used in the search. In this regard an image may have multiple descriptive words and phrases associated with it for searching purposes. Some words or phrases are likely to be more relevant to the image than other words or phrases. The words and phrases may describe elements of the image in the foreground or background of the image. They may also describe subjective themes and concepts represented in the image. The ImageRank (IR) can be measured and calculated for every word and phrase associated with each image in the catalogue.

For example, in the case of an image having a cat in the foreground of the image and a dog in the background of the image, the image is more likely to be relevant to users searching for pictures of ‘cats’ than for users searching for pictures of ‘dogs’, although the word ‘cat’ and the word ‘dog’ are applicable to the image. By calculating the ImageRank (IR) for both keywords, the system can establish a score that disregards activity by users whose searches are not relevant to the principle subject of an image. If the image is popular among users searching for ‘cat’ but less popular among users searching for ‘dog’, calculation of the ImageRank (IR) on a per image per keyword basis avoids lowering the score of an image that is performing well for certain searches.

In cases where the number of poorly performing words and phrases used in searching is disproportionately high relative to the number of popular words and phrases used in such searching, average IR values may be applied to such poorly performing words and phrases.

In a development, in addition to searching using key words or phrases it is possible to search using a visual search tool that enables a user to request images that are visually similar to a key image supplied. If required the search may use a combination of textual and visual image matching to retrieve images. Whether visual image matching is used in addition to or instead of key word searching the search results are ranked in a similar way to that already described above.

In a further development, it is possible for the results of a search to be displayed in two or more different ways in different parts of the display screen. For example, images may be ranked in one way or according to one criterion on one side of the screen and in another way or according to another criterion on the other side of the screen.

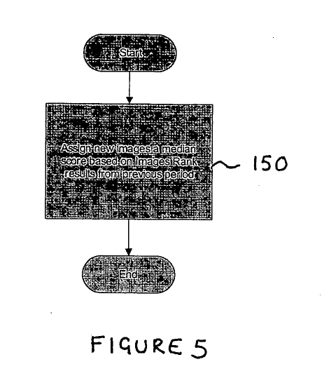

FIG. 5 is a flow diagram illustrating the method of applying a ranking to newly uploaded images that have not yet had a ranking score applied to them. These can be new images from new contributors, new images from existing contributors, or images from existing contributors that have had an insufficient number of viewings for a ranking to be established. In step 150 a score may be allocated to these images corresponding to the median score of all IR groups already in the system. This ensures that new images are given some exposure but that they are neither hidden from view nor dominate the results of searches until they have received a higher number of viewings from which a more reliable IR score can be derived.

1. A method of determining a ranking score for an image or group of related images among a plurality of images accessible by a search engine, such that the ranking score is usable to determine the order in which the images are presented in the results of a search conducted by the search engine, the method comprising:
monitoring the number of times said image or said images in said group of related images are presented for viewing by predetermined users in the results of searches conducted by the search engine,
monitoring a level of active interest shown by said predetermined users in said image or images presented for viewing in said search results, and
determining a ranking score for said image or images based on the monitored level of active interest as a proportion of the number of times said image or images are presented for viewing by said predetermined users.

2. A method as claimed in claim 1, wherein said level of active interest is determined based on the number of purchases of said image or said related images by said predetermined users.

3. A method as claimed in claim 1, wherein said level of active interest is determined based on the overall value of purchases of said image or said related images by said predetermined users.

4. A method as claimed in claim 1, wherein said level of active interest is determined based on the number of instances of viewing in detail of said image or said related images by said predetermined users.

5. A method as claimed in claim 4, wherein said viewing in detail of said image or images comprises user selection of said image or one of said related images for viewing at increased size relative to other images presented in said search results.

6. A method as claimed in claim 1, wherein said level of active interest is determined based on the number of instances of viewing of associated textual data, such as author, price and availability information, relating to said image or said related images by said predetermined users.

7. A method as claimed in claim 1, wherein the method further comprises receiving user input search criteria during a search, identifying images with metadata matching the input search criteria, and presenting the images selected as a result of the search for viewing by the user.

8. A method as claimed in claim 1, wherein the method further comprises receiving user profile data indicative of general preferences of a user conducting a search on the basis of user specified search criteria separate from the user profile (UP) data and correlating the user profile data with image profile data associated with each image or group of related images presented for viewing by the user in the results of the search, whereby the order in which the images are presented in the results of the search is influenced by such correlation.

9. A method as claimed in claim 1, wherein the method further comprises receiving customised user profile data indicative of specific preferences, such as type of audience for the image, of a user conducting a search on the basis of user specified search criteria separate from the current user profile data and correlating the current user profile data with image profile data associated with each image or group of related images presented for viewing by the user in the results of the search, whereby the order in which the images are presented in the results of the search is influenced by such correlation.

10. A method as claimed in claim 1, wherein the method further comprises receiving user importance data indicative of the importance of a user based on factors such as the type of user and the recent purchasing history of the user, and taking into account the user importance data of each of said predetermined users in said determination of the ranking score for said image or images based on the monitored level of active interest shown by said predetermined users in said image or images.

11. A method as claimed in claim 1, wherein the images accessible by the search engine are classified according to type, such as image type or potential customer type, and a ranking score is determined for the ranking of the image or images within the images of each type based on the monitored level of active interest as a proportion of the number of times said image or images are presented for viewing.

12. A method as claimed in claim 1, wherein the change of the ranking score allotted to an image or images in a group of related images is monitored over time, and an accelerated ranking score is imparted to the image or images based on extrapolation of the trend in the change of the ranking score over time indicated by such monitoring.

13. A method as claimed in claim 1, wherein the results of a search are presented for viewing in the form of a plurality of thumbnail images on one or more displayed pages and the relative positions of the thumbnail images on each page are determined by the relative ranking scores of the images.

14. A processor for determining the order in which images are presented in the results of a search through an image catalogue conducted by a search engine, the processor comprising:
first monitoring means for monitoring the number of times an image or images in a group of related images are presented for viewing by predetermined users in the results of searches conducted by the search engine,
second monitoring means for monitoring a level of active interest shown by said predetermined users in said image or images presented for viewing in said search results, and
ranking means for determining a ranking score for said image or images based on the monitored level of active interest as a proportion of the number of times said image or images are presented for viewing by said predetermined users, the order in which the images are presented being dependent on their ranking score.

15. A processor as claimed in claim 14, wherein said level of active interest is determined based on purchases of said image or images by said predetermined users.

16. A processor as claimed in claim 14, wherein said level of active interest is determined based on the number of instances of viewing in detail of said image or images by said predetermined users.

17. A processor as claimed in claim 14, wherein user profile data receiving means is provided for receiving user profile data indicative of general preferences of a user conducting a search on the basis of user specified search criteria separate from the user profile data, and wherein correlation means is provided for correlating the user profile data with image profile data associated with each image or group of related images presented for viewing by the user in the results of the search, whereby the order in which the images are presented in the results of the search is influenced by such correlation.

18. A processor as claimed in claim 14, wherein current user profile data receiving means is provided for receiving current user profile data indicative of specific preferences, such as type of audience for the image, of a user conducting a search on the basis of user specified search criteria separate from the current user profile data, and wherein correlation means is provided for correlating the current user profile data with image profile data associated with each image or group of related images presented for viewing by the user in the results of the search, whereby the order in which the images are presented in the results of the search is influenced by such correlation.

19. A processor as claimed in claim 14, wherein user importance data receiving means is provided for receiving user importance data indicative of the importance of a user based on factors such as the type of user and the recent purchasing history of the user, the user importance data of each of said predetermined users being taken into account in said determination of the ranking score for said image or images based on the monitored level of active interest shown by said predetermined users in said image or images.

20. A computer readable storage medium incorporating a computer program for carrying out a method of determining a ranking score for an image or group of related images among a plurality of images accessible by a search engine, such that the ranking score is usable to determine the order in which the images are presented in the results of a search conducted by the search engine, the method comprising:
monitoring the number of times said image or said images in said group of related images are presented for viewing by predetermined users in the results of searches conducted by the search engine,
monitoring a level of active interest shown by said predetermined users in said image or images presented for viewing in said search results, and
determining a ranking score for said image or images based on the monitored level of active interest as a proportion of the number of times said image or images are presented for viewing by said predetermined users.
